(19) United States
(12) Patent Application Publication
(10) Pub. No.: US 2025/0289188 A1
(43) Pub. Date: Sep. 18, 2025

(54) Peel and Stick Installation Device

(71) Applicant: William James Dorsey, IV, Greenville, NC (US)

(72) Inventor: William James Dorsey, IV, Greenville, NC (US)

(21) Appl. No.: 18/603,886

(22) Filed: Mar. 13, 2024

(51) Int. Cl. B29C 65/78

(52) U.S. Cl. CPC B29C 65/7841

(57) ABSTRACT

The Peel and Stick Installation Device is a hand-held device to aid with the installation of wallcoverings commonly referred to as the “peel and stick” variety. The device controls the adhesive side of the wallcovering, limiting and releasing unwanted contact between the adhesive and the wall until alignment is achieved. It is designed to assist both professional, novice, and beginner wallpaper installers.

### CROSS REFERENCE TO RELATED APPLICATIONS

The present application claims priority to U.S. provisional patent application Ser. No. 63/576,889, filed on Mar. 13, 2023.

The entire disclosure is included herein its entirety at least by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### STATEMENT REGARDING PRIOR DISCLOSURES BY THE INVENTOR OR A JOINT INVENTOR

Not applicable

### BACKGROUND OF THE INVENTION

Wallpaper installers or “paper hangers” of traditional wall coverings typically apply a paste to the back of wall coverings before aligning and installing them on the wall.

Paste serves a dual purpose. Obviously, it's a bonding agent. Equally important but less obvious is its initial role as a lubricant. It enables the paperhanger to slide the wallcovering in any direction until alignment is achieved on the wall. This is known in the Trade as “slipping the paper”. As it dries the “slip” of the paste lessens and a bond between the two surfaces is formed.

With the invention of wall coverings known as “peel and stick” in the late 1960's a new type of adhesive was introduced to the industry. As its name implies, this adhesive is sticky with absolutely no “slip.”

In short, peel and stick wall coverings are a decorative paper or synthetic material that is manufactured with a pre-applied sticky adhesive. This adhesive is covered with a nonstick backing similar to waxed paper that is peeled away before installing.

Once exposed, this adhesive is similar to a contact cement with the potential to stick to everything it touches, including itself.

As one can imagine, the “non-slip, all grip” nature of this adhesive can present a frustrating installation challenge. Common problems include, but are not limited to: difficult alignment, trapped air pockets and or bubbles, along with stubborn creases and wrinkles. Any of which can ruin an installation. Many installers novice and professional alike often resort to enlisting a friend or partner to help install this particular wallcovering because until this device, installation frequently required 3 or more hands

This device limits and releases unwanted contact with the wall and the adhesive backing of wallcoverings commonly known as peel and stick. It is also the key component to a method which greatly reduces or eliminates the aforementioned installation problems while increasing installation speed and eliminating the necessity of a helper.

### FIELD OF THE INVENTION

A tool, more specifically a device which helps while installing wall coverings commonly known as “peel and stick”.

### BRIEF SUMMARY OF THE INVENTION

The inventor provides a unique device and method to install wall covering commonly known as “peel and stick.” The device limits and releases unwanted contact with the wall and the adhesive backing of wallcoverings referred to as peel and stick. It is also the key component to a method which greatly reduces or eliminates the occurrence of common installation issues including, but not limited to, creases and trapped air bubbles. Additionally, this device increases installation speed while eliminating the necessity of a helper.

### BRIEF DESCRIPTION OF VIEWS OF DRAWINGS

FIG. 1—PEEL AND STICK INSTALLATION DEVICE

Manufacturers are exploring the manageable size and weight limitations of wall coverings commonly known as “peel and stick”

FIG. 1 is an idealized version of my device, which is relevant to modern day industry standards and measurements of wallcovering known as peel and stick. The dimension of my device will evolve to match the ever-changing dimension and weights of peel and stick wallcoverings, whatever the size. All variations listed have similar lengths and widths as FIG. 1.

The device is comprised of two hollow acrylic cylinders: 101 and 102. 101 is longer than 102 by a margin that allows 102 to rotate freely around 101 after caps 103 have been placed on each end of 101. 101 has a diameter that is also slightly narrower than 102 which allows 102 to rotate around 101. 103 serves both as retaining caps for cylinder 102 and handles for the device.

FIG. 2—VARIATION A

A single cylinder, solid or hollow with a bearing 201 inserted in each end. A single Finger 202 can be inserted into each bearing which allows the device to rotate while in use.

FIG. 3—VARIATION B

A single cylinder, solid or hollow with a bearing inserted into each end. A short rod 301 acting as a handle is affixed to the center of each bearing allowing the device to be held by fingers 302 and rotate while in use.

FIG. 4—VARIATION C

A single cylinder solid or hollow with dimples 401 on the end which allows the device to rotate on fingers 402 while being used.

FIG. 5—VARIATION D

A single hollow cylinder 501 which allows the device to rotate on the fingers 502 while being used.

FIG. 6—VARIATION E

The exterior of the devices in figures #1-#5 may be smooth or exhibit a pattern of slightly raised ridges 601 to limit contact of its surface with the wallcovering adhesive.

FIG. 7—VARIATION F

The exterior of the devices in figures #1-#5 may be smooth or exhibit a pattern of random or orderly protrusions 701 to limit contact of its surface with the wallcovering adhesive.

### DETAILED DESCRIPTION OF THE INVENTION

The present invention is described in enabling detail in the following examples, which may represent more than one embodiment of the present invention.

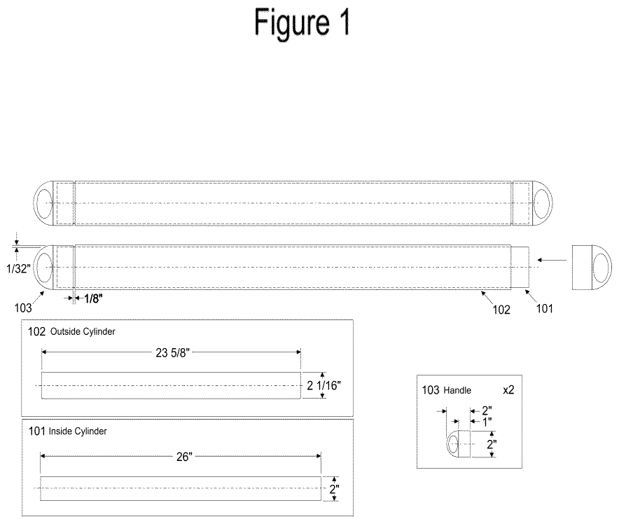

### FIG. 1

The device can be comprised of two cylinders 101 and 102 Either or both cylinders can be made of synthetic or natural materials. The relative circumference of the cylinders must be of tolerances which allow the exterior cylinder 102 to rotate smoothly around the internal cylinder 101 The internal and smaller diameter cylinder 101 is slightly longer which will allow caps 103 to be placed on each end without limiting rotation of 102 around 101. The caps 103 retain the exterior, rotating cylinder 102 on the inner cylinder 101 and also serve as handles for the device.

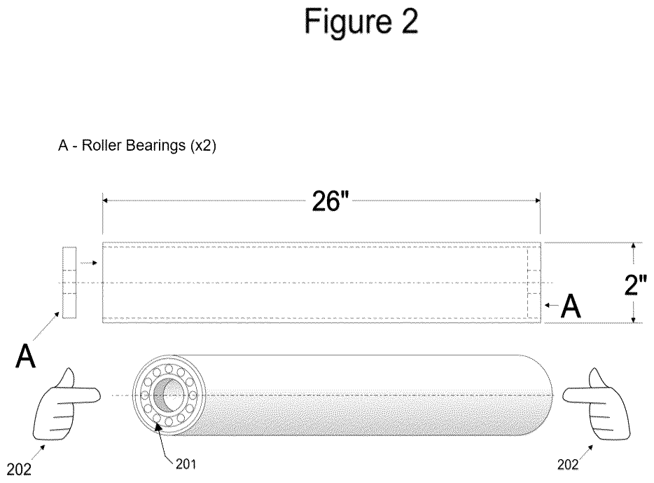

### FIG. 2—Variation A

A single cylinder, solid or hollow with a bearing 201 inserted in each end. A single Finger 202 can be inserted into each bearing which allows the device to rotate while in use.

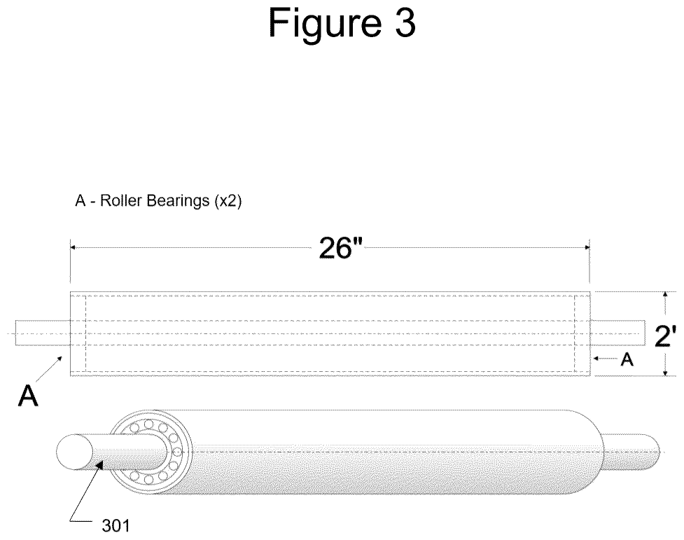

### FIG. 3—Variation B

A single cylinder, solid or hollow with a bearing inserted into each end. A short rod 301 acting as a handle is fixed into the center of each bearing allowing the device to be held by fingers and rotate while in use.

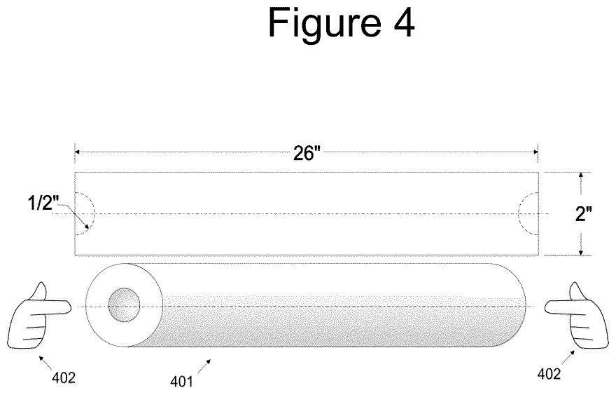

### FIG. 4—Variation C

A single cylinder solid or hollow with dimples 401 on the end which allows the device to rotate on fingers 402 while being used.

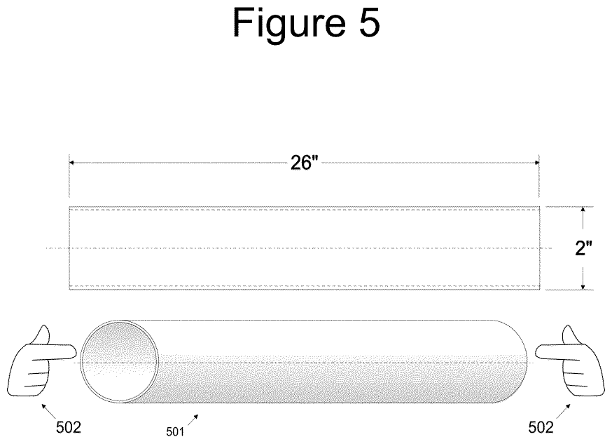

### FIG. 5—Variation D

A single hollow cylinder 501 which allows the device to rotate on the fingers 502 while being used

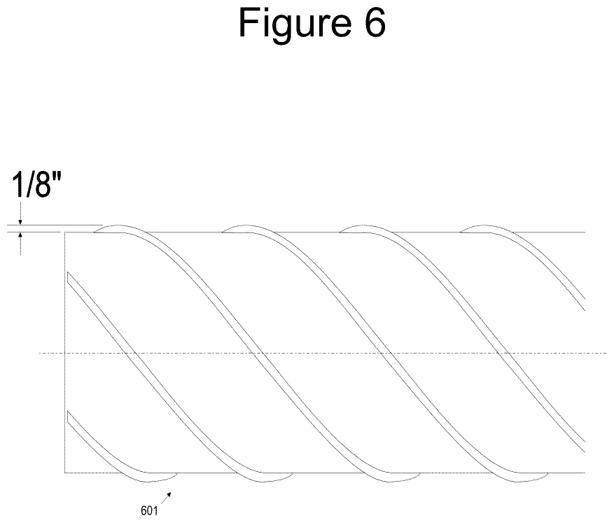

### FIG. 6—Variation E

The exterior of the devices in figures #1-#5 may be smooth or exhibit a pattern of slightly raised ridges 601 made of silicone or another nonstick material to limit contact of its surface with the wallcovering adhesive.

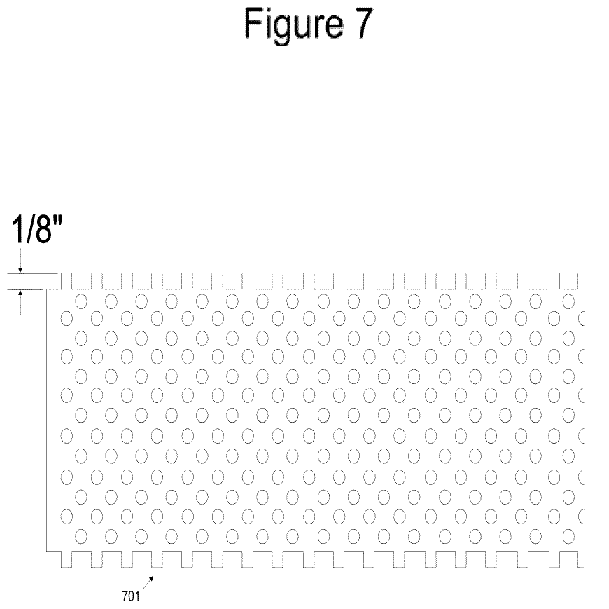

### FIG. 7—Variation F

The exterior of the devices in figures #1-#5 may be smooth or exhibit a pattern of random or orderly protrusions 701 made of silicone or another nonstick material to limit contact of its surface with the wallcovering adhesive.

Uses for this device include but are not limited to the following directions.

The installation goal is to avoid or minimize unwanted contact with the sticky adhesive backing of this type of wallcovering.

A two-step smoothing method works best during installation of wallcovering commonly known as peel and stick. If aligned properly no more than a LIGHT touch will be required during the initial contact. If not properly aligned a LIGHT touch will also ease the unsticking of that section from the wall. After smoothing with a LIGHT touch and inspection reveals no imperfections, smooth over the entire section again. This time with Vigor.

### Instructions for Use

The first step is to establish true vertical alignment of a contact or anchor band from which the rest of the wallcovering will freely hang.

The first alignment sequence is of paramount importance. Each subsequent strip will use the next as a plumb line.

Establish a true vertical or plumb line with a level. This line is measured from the starting point which will be a corner or edge to the far left. Its width will be approximately ¼ inch narrower than the first strip to allow for slight imperfections of the starting corner or edge.

After establishing a plumb line, with the wallcovering face down on a table, peel the non-stick backing from the top of the strip down to expose approximately 10 inches of adhesive.

Approximately 7 inches will serve as an anchor. The remaining 3 inches will later be the first contact point of the device.

After exposing approximately 10 inches, lightly crease and fold the separated non-stick backing over.

This alignment sequence requires moderate dexterity and concentration. Care must be taken to use the left hand to keep the rest of the wallcovering from contacting the wall while the other is aligning the right side.

Pick up the wall coverings by the corners with the design side facing the installer. Align and stick it along the plumb line using the right-hand thumb to press/contact the exposed right vertical edge to and down along the line beginning slightly below the ceiling and continuing down towards the remaining backing for about seven inches.

After establishing this line of contact use the thumb or finger to widen this contact area to about 2 inches. Press this 2×7 inch section with Vigor.

An accurate alignment and positive contact of this 2×7 inch vertical band is critical. This strip and each additional strip along this wall will rely on its correct placement.

Meanwhile the left hand is loosely holding and preventing the rest of the exposed adhesive from contacting the wall.

The next step is to “permanently” stick this entire 7 inch horizontal anchor section to the wall.

Eliminate the slack from the anchor section by slowly moving your left hand up, towards the starting corner or edge. Do not touch the wall but when close to it, pause to observe and “feel” this section of covering. Your aim is to pull straight across from the right.

The wallcovering will literally let the installer know when it is positioned correctly by an absence of wrinkles and diagonal stress. Indeed, when positioned correctly it will practically lay flat on its own. When it is perceived to be in position, LIGHTLY use the palm of the right hand to sweep from the original 2×7 inch alignment band across the middle to the left side with two horizontal and slightly overlapping descending strokes. This will secure/bond a six to seven inch wide band of previously exposed section of wall covering adhesive to the wall. This is now the “anchor area”. If this area doesn't lay flat, simply lift it off from left to right stopping short of the original 2×7 alignment band. Repeat the process until it lays flat. Once it lays flat repeat the smoothing strokes with vigor and a sense of permanence. It is essential that optimum contact is achieved between the wall and adhesive because the anchor section must resist the pull exerted while peeling the remaining non-stick backing from the wallcovering.

Done properly the remainder of the unexposed wallcovering will hang by the anchor band down along the wall with its right edge remarkably close to the plumb line.

After pressing the anchor band securely in place, lift the sheet slightly below the exposed adhesive making enough space to slide the device along the wall horizontally. Lay and stick the remaining 3 inches of exposed adhesive to the device. It should be positioned horizontally, directly below the anchor band and above the non-stick backing.

This positioning allows the wallcovering to drape over the device. The remaining non-stick backing can now be removed allowing the adhesive to be exposed while presenting the device as a sole point of contact.

The balance of the non-stick backing can now easily be peeled off by simultaneously grasping it from both sides slightly below the device and pulling it to the floor.

Depending on the size of device, length and type of covering, the exposed covering will now hang free or cling softly to the wall.

To prevent twisting and to eliminate the possibility of back-to-back adhesive contact, lift the covering and stick a single cylinder to it about three (3) inches from the floor.

Grasp the top/first device by its handles. Gently pulling it slightly away from the wall and roll it downward to release all unwanted contact between wall covering and wall for approximately 4 ft.

The user can determine the distance deemed manageable. Three (3) to four (4) ft is recommended.

Once the desired distance is reached, reestablish a “holding contact” between the adhesive and device with firm pressure the device will remain in place. The wallcovering above the device and below the anchor strip will be unstuck allowing gravity to rest this section of wall covering gently on the wall and close to the established plumb line.

The loosely hanging approximately four (4) ft. section of wall covering above the device can now be easily aligned to the plumb line. Gently grasp the right side of the paper about 2 inches above the device and pull it down and towards the wall making it taught, but without stretching. Press it to the wall with a firm thumbs touch to the plumb line. Keep the right thumb in place Use the left thumb and forefinger to gently tighten the left side and contact the wallcovering to the wall with the thumb. This 4 ft. section is now aligned and can be “permanently” smoothed to the wall by LIGHTLY sweeping a hand or tool from the middle of the anchor section straight down the four (4) foot section stopping short of the device.

This sequence removes the possibility of entrapping air in the middle of the sheet by making contact with the middle first.

The next two steps take advantage of this division by eliminating air from the middle to the right, and then middle to the left making contact in that order.

Continue by repeating the motion of sweeping a hand or smoothing tool from the top middle of the anchor band out to the top right edge with descending overlapping horizontal strokes. Smooth the left side in a similar fashion but from the top middle to the top left while descending with overlapping horizontal strokes.

Repeat this procedure from paragraph by lifting and moving the device downward in comfortably manageable sections, aligning and smoothing the covering until reaching and removing the last device and completing installation of the strip.

I claim:

1. A device with a rotating or stationary surface which controls and limits unwanted contact with the adhesive backing of peel and stick wall coverings during its installation.
